(19) United States
(12) Patent Application Publication
(10) Pub. No.: US 2015/0183964 A1
(43) Pub. Date: Jul. 2, 2015

(54) PARTICLATE SOLID, PROCESS FOR THE PRODUCTION THEREOF, USE AS FILLER AND ASSOCIATED ARTICLES

(71) Applicant: Evonik Industries AG, Essen (DE)

(72) Inventors: Stephen Witte, Sehnde (DE); Wolfram Herrmann, Wunstorf (DE)

(73) Assignee: Evonik Industries AG, Essen (DE)

(21) Appl. No.: 14/407,186

(22) PCT Filed: Dec. 18, 2012
(86) PCT No.: PCT/EP2012/075927

§ 371 Date: Dec. 11, 2014

(30) Foreign Application Priority Data
Jan. 9, 2012 (DE) 10 2012 100 123.5

(51) Int. Cl. C08K 9/06; C09C 1/30; C09C 3/12

(52) U.S. Cl. CPC C08K 9/06; C09C 3/12; C09C 1/3081; C01P 2006/12

(57) ABSTRACT

The inorganic oxidic filler of the invention has hydrolysis-resistant peroxy functionalization and is specifically suitable for bonding into polymer mixtures crosslinked by a free-radical root, in particular in technical items composed of polymer or of elastomer, for example tires, tire components, drive belts, drive belt components, air springs, conveyor belts, hoses, gaskets, etc. Peroxyorganosiloxane groups are bonded here by way of oxygen to oxides of silicon, aluminum, magnesium, calcium, zinc, zirconium, and/or titanium. Preferred surface-function groups which can be produced by various variants of the process are

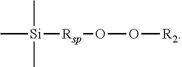

The invention relates to the field of modern hybrid materials made of organic and inorganic materials, namely in particular polymers filled with inorganic oxidic fillers. Important fields of application for elastomeric polymers of this type are tires, drive belts, air springs, conveyor belts, hoses, etc.

Properties of the finished material are determined in elastomers and other polymers not only by the choice of the polymer but also by fillers. The fillers most frequently used in elastomer technology are carbon blacks and silicas. While carbon blacks generally have very good compatibility with polymers, silicas and other metal and semimetal oxides similarly used do not have this property, because they have a polar, hydrophilic surface. Property improvement is achieved not only by the fillers but also by other additives. There is a very high level of interest in raw materials that can be used to produce materials providing better performance.

Among the additives used in the sector are inter alia peroxides. These are used as free-radical initiators and crosslinking agents. Polymerized plastic precursors which are initially still amenable to molding are crosslinked or cured with exposure to heat after the molding process. The concentration required of the peroxide used for this purpose is relatively small, and the peroxide should have the best possible distribution in the uncured mixture. Other additives, and the filler, also require distribution in the mixture. Fixing of a peroxide on the filler therefore appears to be an objective that is of interest.

WO 2005/061631 discloses processes for binding nucleophiles on the surface of particles of oxidic compounds of metals and/or semimetals M. This is achieved with high efficiency by using silicon halides SiX₄. M—O—Si—X groups are formed, starting from M—O—H groups, at the surface, and the halogen of these is nucleophilically substitutable. However, the introduction of peroxide groups via hydroperoxy compounds by that method is not a suitable route, since the binding achieved proves to be susceptible to hydrolysis. When fillers of that type are used in elastomers, premature cleavage of hydroperoxide occurs in the parent mixtures, leading to highly undesirable aging phenomena.

DE 2,247,885 discloses organosilicon compounds having peroxide groups in the molecule which are advantageous as adhesion promoters to improve the binding of unsaturated organic resins, in particular polyester resins, to organic substrates. The organosilicon compounds have the general structure

RₘX₃₋ₘSiR′OOR″,

in which R is alkyl or phenyl, X is an alkoxide, mentioned above, and R′ and R″ are other organic moieties. However, the use of this adhesion promoter for in-situ silanization of a filler in the manner known per se is unsuccessful because the temperatures required for the silanization reaction in the mixer cause premature decomposition of the peroxide.

The object of the invention therefore consists in providing an inorganic oxidic filler for polymers and in particular elastomers which has peroxide functionalities securely anchored on the filler surface, and also a process for production of same.

The invention in particulate relates to particulate solids suitable as filler which are composed of inorganic oxidic compounds of the elements silicon, aluminum, magnesium, calcium, zinc, zirconium, or titanium—generally termed M—as are well known in the sector.

A particulate solid of the invention, within this generic type, features surface-bonded peroxyorganosiloxane groups covalently bonded on the M-O surface and obtainable for the first time by the particular processes of this invention.

The expression “inorganic oxidic compounds” here means a very wide variety of oxides and hydroxides, and also oxo acids, oxo anhydrides, and salts of metals and of nonmetals of the abovementioned group. Phosphates, sulfates, and nitrides can be present. The group moreover comprises mixed forms M₁M₂OₙHₘ . . . , which may also be in mixed crystal form with other salts. This inorganic oxidic filler group has amorphous and crystalline members. Within this group, particular importance is attached to the silica derivatives, among which are primarily (ortho)silicic acid, silica gel, silica, siliceous earth, and kieselguhr, and also various forms of water glass. Particular importance is attached here to precipitated and fumed silicas. In general terms, this group includes all variants, derivatives, and products of, and with, silicon dioxide(SiO₂). Among the inorganic oxidic parent substances for the purposes of this invention are also the titanium oxides, zinc oxide, zirconium oxide, aluminum oxide, aluminosilicates, calcium oxide, calcium sulfate, magnesium oxide, aluminum magnesium oxide, and other mixed forms of the abovementioned elements. The use as filler is known per se for all of these parent substances.

The term “functionalization” here means primarily chemical or physicochemical modification at the surface of a solid particle. The functionalization is aimed at adapting the particles used as filler, or as composite material in hybrid materials, in respect of use of said particles, so that they are suitable for the respective intended use, and thus at providing particular properties to said particles. To this end, functional groups are introduced at the surface, i.e. particular chemical groups of the untreated particles are substituted in such a way that covalently bonded groups not possessed by the untreated particle are anchored on the surface. This does not exclude the possibility that porous solids can have been functionalized to some extent in the interior or in relatively deep-lying surface regions, or that fine-particle fillers can be functionalized and then aggregated, in such a way that functional groups are additionally likewise present in the interior of the particles.

The untreated particles can also take the form of what are known as core-shell particles. Said particles have a core made of any desired material, covered by a solid shell or, respectively, a full covering of surface layer made of one of the abovementioned inorganic oxidic materials.

The term “silanization” hereinafter means functionalization with organosilanes. The organosilanes here have the general structure I

Y₍₄₋ₙ₎SiR₁ₙ, where n is from 1 to 3. (I)

R₁ here is the organic moiety that is to be anchored on the surface of the inorganic oxidic solid particle, and Y₍₄₋ₙ₎ is at least one hydrolyzable leaving group which reacts with formation of covalent bonds with the OH groups of the solid surface. Y here is mutually independently branched or unbranched alkyl, preferably C₁ to C₁₈, particularly preferably methyl(-CH₃), ethyl(-CH₂—CH₃), isopropyl(-CH(CH₃)—CH₃), propyl(-(CH₂)^{2—CH}₃), or C₄ to C₁₈ alkyl,

branched or unbranched alkoxy, preferably branched or unbranched C₁ to C₂₂ alkoxy, particularly preferably methoxy(-O—CH₃), ethoxy(-O—CH₂—CH₃), isopropoxy(-O—CH(CH₃)—CH₃), propoxy(-O—(CH₂)₂—CH₃), butoxy(-O—(CH₂)₃—CH₃), pentoxy(-O—(CH₂)₄—CH₃), hexoxy(-O—(CH₂)₅—CH₃), or C₇ to C₂₂ alkoxy, branched or unbranched C₂ to C₂₅ alkenyloxy, preferably C₄ to C₂₀ alkenyloxy, C₆ to C₃₅ aryloxy, preferably C₉ to C₃₀ aryloxy, particularly preferably phenyloxy(-O—C₆H₅),

branched or unbranched C₇ to C₃₅ alkylaryloxy group, preferably benzyloxy(-O—CH₂—C₆H₅), or 2-phenylethoxy(-O—(CH₂)₂—C₆H₅),

branched or unbranched C₇ to C₃₅ arylalkyloxy group, preferably tolyloxy(-O—C₆H₄—CH₃), halide, preferably chloride or bromide, particularly preferably chloride,

an alkoxyalkoxy group of the general formula —O—R′—O—R″, where R′ and R″ mutually independently can be a branched or unbranched, saturated or unsaturated, substituted or unsubstituted, aliphatic, aromatic, or mixed aliphatic/aromatic hydrocarbon group, preferably methyl(-CH₃) and, respectively, methylene(-CH₂—), ethyl(-CH₂—CH₃) and, respectively, ethylene(-CH₂—CH₂—), propyl(-(CH₂)₂—CH₃) and, respectively, propylene(-(CH₂)₃—),

an amine of the general formula —NR₂, where R are mutually independently H, a branched or unbranched, saturated or unsaturated, substituted or unsubstituted, aliphatic, aromatic, or mixed aliphatic/aromatic hydrocarbon group, preferably an aliphatic C₁ to C₆ alkyl group, particularly preferably methyl(-CH₃), ethyl(-CH₂—CH₃), propyl(-(CH₂)₂—CH₃), isopropyl(-CH(CH₃)—CH₃), or butyl(-(CH₂)₃—CH₃),

oxycarbonyl of the general formula —O—CO—R, where R is H, a branched or unbranched, saturated or unsaturated, substituted or unsubstituted, aliphatic, aromatic, or mixed aliphatic/aromatic hydrocarbon group, preferably an aliphatic C₁ to C₆ alkyl group, particularly preferably methyl(-CH₃), ethyl(-CH₂—CH₃), propyl(-(CH₂)₂—CH₃), isopropyl(-CH(CH₃)—CH₃), or butyl(-(CH₂)₃—CH₃).

Most preference is given among these to methoxy(-O—CH₃), ethoxy(-O—CH₂—CH₃), isopropoxy(-O—CH(CH₃)—CH₃), and propoxy(-O—(CH₂)₂—CH₃).

Silanization processes per se are well described in the literature, and therefore do not require further explanation here.

In mechanistic terms, the siloxane compounds are formed in two steps: the primary and the secondary reaction. The primary reaction involves the reaction of the organofunctional silane with the silanol groups of the solid, for example of the silica, where the hydrolyzable groups of the silane are cleaved. In the secondary reaction, crosslinking of the silane molecules immobilized on the surface takes place. The secondary reaction takes place more slowly than the primary reaction. Both reactions can be accelerated by using acidic or basic pH. Increased water concentration in the organic solvent likewise accelerates the reaction.

Three different methods can be used to react the filler with the organofunctional silane:
in-situ process: The organofunctional silane is added to the rubber mixture or, respectively, to the polymer to be provided with filler, in a mixer during the filler-dispersion phase (preferred reaction temperature: from 140 to 160° C.)
Wet process: the silane is added to an aqueous filler suspension and is then reacted at elevated temperature (preferred reaction temperature: 80° C.)
Dry process: filler and silane are mixed with one another in a mixer, and are then reacted at elevated temperature (preferred reaction temperature: 120° C.)

From the conditions it is apparent that the introduction of peroxy groups cannot be achieved by way of in-situ silanization, as is conventional in elastomer technology, using peroxysilanes. The solution to the problem therefore moreover comprises particular processes, described in more detail hereinafter.

All of the processes give particulate inorganic oxidic solids suitable as filler which preferably have peroxyorganosiloxane groups having the following structure II:

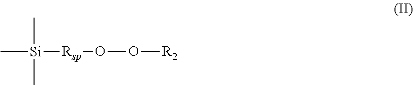

where Rₛₚ is a spacer group of aliphatic, arylic, or mixed aliphatic/arylic structure. The spacer group can comprise, as appropriate to the synthesis variant, heteroatoms, pendant chains, or other functional groups, for example multiple bonds, ethers, amides, esters, or anhydrides. It serves merely as place-holder between filler particle and peroxide functionality. The description of the various synthesis variants provides an exact definition of, and examples of, spacer groups.

R₂ is a branched or unbranched, saturated or unsaturated, substituted or unsubstituted, aliphatic, aromatic, or mixed aliphatic/aromatic monovalent hydrocarbon group, preferably methyl(-CH₃), ethyl(-CH₂—CH₃), n-propyl(-(CH₂)₂—CH₃), isopropyl(-CH(CH₃)—CH₃), n-butyl(-(CH₂)₃—CH₃), isobutyl(-CH₂—CH(CH₃)—CH₃), tent-butyl(-C(CH₃)₃), 1,1-dimethylbenzyl(-CH₂—C(CH₃)₂—C₆H₅), 1-methylbenzyl(-CH₂—CH(CH₃)—C₆H₅), benzyl(-CH₂-C₆H₅), acetyl(-CO—CH₃), propanoyl(-CO—CH₂—CH₃), benzoyl(-CO—C₆H₅), m-chlorobenzoyl(-CO—C₆H₄Cl), and p-chlorobenzoyl(-CO—C₆H₄Cl). Particular preference is given to methyl(-CH₃), tert-butyl(-C(CH₃)₃), 1,1-dimethylbenzyl(-CH₂—C(CH₃)₂—C₆H₅), acetyl(-CO—CH₃), and benzoyl(-CO—C₆H₅).

The modified particulate solid comprises the peroxyorganosiloxane groups covalently bonded on its surface.

Tests have shown that genuine covalent bonding is present, giving the peroxide functionality. The grafted peroxide groups are stable for some time at 100° C. Decomposition begins only when temperatures of from 160 to 180° C. are reached. The peroxide function acts in the desired manner like a peroxide additive. The desired effect is obtained within the polymer-filler mixture, and the free-radical cleavage of the peroxide from the filler also leads to direct covalent bonding between filler and polymer. This is seen in higher tensile strength values, higher moduli, higher abrasion resistance values, lower compression set values, and in the case of tire applications lower rolling resistance. The relatively low level of internal friction leads moreover to relatively little evolution of heat in the material. The effects mentioned are advantageous when comparison is made with the same quantity of unmodified fillers mixed into the material.

Desired decomposition temperatures for the particles described are from 100° C. to 220° C. Particular preference is given here to decomposition temperatures of from 160° C. to 180° C.

In the synthesis variants described hereinafter in the invention, the filler surface is first silanized, and only then is the desired peroxide functionality introduced. Since the silanization reaction is not carried out in situ in the mixer, greater homogeneity of the product can moreover be expected. The silanized fillers obtained, equipped with peroxide functionalities, are capable of forming covalent bonds to the polymer. The fillers described here are not dependent on multiple bonds or other functional groups of the polymer. They are in principle capable of forming covalent bonds with any polymer that can be peroxidically crosslinked. A further advantage is that, by virtue of local overcrosslinking at the filler particle, the grafted peroxide groups give a slower rise of modulus between polymer and filler. This has an advantageous effect on the physical and dynamic properties of the finished material. The fillers described moreover have good shelf life, are resistant to hydrolysis, and are stable at the conventional mixing temperatures.

In a first aspect of the invention, the particulate inorganic oxidic solid suitable as filler is produced in the invention by a process in which the filler is silanized with an organosilane which comprises a nucleophilically substitutable leaving group, and in a subsequent step the leaving group here is substituted by a hydroperoxy compound with the aid of a base and more preferably with the aid of a phase-transfer catalyst.

Organofunctional silanes required for this process are those that have, alongside the hydrolyzable groups required for the binding to the filler (siloxane formation), an aliphatic moiety with a nucleophilically substitutable leaving group that is, as far as possible, terminal

The steps for this process of variant 1 are accordingly:
silanization of the particulate solid with an organosilane which comprises at least one nucleophilically substitutable leaving group per molecule, or provision of a solid silanized in this manner,
reaction of the solid during the silanization in a one-pot reaction or reaction of the silanization product (base-catalyzed) with a hydroperoxy compound.

Use of a ready-silanized filler, many types of which are nowadays obtainable commercially, is of course equivalent to the silanization of a parent filler.

The following moieties are suitable for the nucleophilically substitutable leaving group: iodide, bromide, chloride, fluoride, hydroxide, cyanide, hydrogensulfate(HSO₄⁻), triflate (CF₃SO₃⁻), methyl sulfate(CH₃SO₄⁻), mesylate(CH₃SO₃⁻), tosylate,(CH₃—C₆H₄—SO₃⁻), carboxylate(RCO₂⁻), amide(R₂N⁻), thiolate(RS⁻), or alcoholate leaving groups (RO⁻), where R is respectively mutually independently H, a branched or unbranched, saturated or unsaturated, substituted or unsubstituted, aliphatic, aromatic, or mixed aliphatic/aromatic monovalent hydrocarbon group, preferably methyl(-CH₃), ethyl(-CH₂—CH₃), n-propyl(-(CH₂)₂—CH₃), isopropyl(-CH(CH₃)—CH₃), n-butyl(-(CH₂)₃—CH₃), isobutyl(-CH₂—CH(CH₃)—CH₃), tert-butyl(-C(CH₃)₃), n-pentyl(-(CH₂)₄—CH₃), n-hexyl(-(CH₂)₅—CH₃), particularly preferably H, methyl(-CH₃), ethyl(-CH₂—CH₃), or n-propyl(-(CH₂)₂—CH₃). Preferred leaving groups are iodide, bromide, chloride, hydroxide, hydrogensulfate (HSO₄⁻), methyl sulfate(CH₃SO₄⁻), triflate(CF₃SO₃⁻), mesylate(CH₃SO₃⁻), and tosylate leaving groups (CH₃—C₆H₄—SO₃⁻), and particular preference is given to iodide, bromide, and chloride leaving groups.

Suitable hydrolyzable groups for the covalent bonding of the silane to the filler are any groups that are conventional for silanization reactions and known to the person skilled in the art and already defined above. Examples here are methoxy groups and ethoxy groups.

A useful spacer group (R_{Sp}) on the Si atom is an unbranched, saturated or mono- or polyunsaturated, aliphatic, or mixed aliphatic/aromatic divalent C₃ to C₃₀ hydrocarbon group having a terminal leaving group. The hydrocarbon group can comprise short pendant chains and/or heteroatoms.

Preferred spacer groups are unbranched alkanediyl moieties-(CH₂)ₓ—, where x=from 3 to 30, among which particular preference is given to —(CH₂)ₓ—, where x=from 8 to 16, and the following unbranched alkanediyl moieties which include a heteroatom, multiple bonds, and/or aromatic systems:

-A-,

-A-(CH₂)ₓ—,

-A-(CH₂)ₓ-A-,

—(CH₂)ₓ-A-(CH₂)ₓ—,

-A-(CH₂)ₓ-A-(CH₂)ₓ—,

-A-(CH₂)ₓ-A-(CH₂)ₓ-A-,

—(CH₂)_{y}-A-(CH₂)_{y}-A-(CH₂)_{y}—,

-A-(CH₂)_{y}-A-(CH₂)_{y}-A-(CH₂)_{y}—,

-A-(CH₂)_{y}-A-(CH₂)_{y}-A-(CH₂)_{y}-A-,

—(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}-A-,

—(CH₂)_{z}-A-(CH₂)_{z}-A-(CH₂)_{z}-A-(CH₂)_{z}-A-(CH₂)_{z}—

where x=from 1 to 30, y=from 1 to 25, z=from 1 to 20, and the group of atoms A=-CH═CH—, —C≡C—, —C₆H₄—, —CO—O—, —CO—N—, —CO—O—CO—, —CO—N—CO—, —NH—CO—NH—, oxygen(-O—), sulfur(-S—), or nitrogen(-NR—), where R═H, alkyl, or alkenyl, particularly preferably where x=from 1 to 20, y=from 1 to 15, z=from 1 to 10, and the group of atoms A=oxygen(-O—), —CH═CH—, or —C≡C—.

Preferred hydroperoxy compounds are hydroperoxides or peroxycarboxylic acids of the general structure III:

R₃—O—O—H (III)

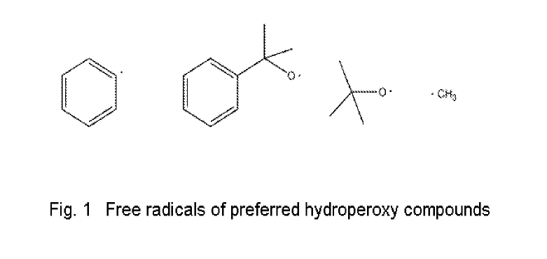

R₃ here is a branched or unbranched, saturated or unsaturated, substituted or unsubstituted, aliphatic, aromatic, or mixed aliphatic/aromatic monovalent hydrocarbon group, preferably methyl(-CH₃), Ethyl(-CH₂—CH₃), n-propyl(-(CH₂)₂—CH₃), isopropyl(-CH(CH₃)—CH₃), n-butyl(-(CH₂)₃—CH₃), isobutyl(-CH₂—CH(CH₃)—CH₃), tent-butyl(-C(CH₃)₃), 1,1-dimethylbenzyl(-CH₂—C(CH₃)₂—C₆H₅), 1-methylbenzyl(-CH₂—CH(CH₃)—C₆H₅), benzyl(-CH₂—C₆H₅), acetyl(-CO—CH₃), propanoyl(-CO—CH₂—CH₃), benzoyl(-CO—C₆H₅), m-chlorobenzoyl(-CO—C₆H₄Cl), and p-chlorobenzoyl(-CO—C₆H₄Cl). Particular preference is given to methyl(-CH₃), tert-butyl(-C(CH₃)₃), 1,1-dimethylbenzyl(-CH₂—C(CH₃)₂—C₆H₅), acetyl(-CO—CH₃), and benzoyl(-CO—C₆H₅), and, respectively, those that form the free radicals depicted in FIG. 1.

The selection of the base is to be such that it permits the base-catalyzed nucleophilic substitution, i.e. in the case of the hydroperoxy compounds preferably used it can deprotonate these. Preferred bases are the hydroxides of the alkali metals and of the alkaline earth metals. Among these, particular preference is given to sodium hydroxide and potassium hydroxide.

It is moreover preferable that the substitution by peroxide on the silane uses phase-transfer catalysis. The phase-transfer catalyst is used to transfer the anion of the hydroperoxy compound into the organic phase. Suitable phase-transfer catalysts are tetraalkylammonium compounds (e.g. Bu₄NHSO₄), phosphonium salts, onium compounds, and polyethylene glycols.

The process parameters, temperature, reaction time, starting material concentrations, and solvents are to be selected by the person skilled in the art so as to be appropriate to the requirements.

An embodiment of the invention provides that, simultaneously with the reaction with the hydroperoxy compound or subsequently a reaction is carried out with at least one other nucleophile, preferably selected from the group of the alcohols, amines, thiols, or carboxylic acids, in order to achieve covalent bonding of other functional groups, instead of or alongside the peroxy groups, on the surface of the solid. This additional process variant is possible for all three of the processes, the description of which in part continues hereinafter. The filler can thus obtain additional properties which are advantageous for particular applications.

Suitable nucleophiles are compounds of the general formula IV

Nu-R₄—X (IV)

where Nu denotes the nucleophilic group, R₄ denotes an organic group of atoms, and X denotes a functional group. Nucleophilic groups can be alcohol(-OH), amino(-NH₂), thiol(-SH), or carboxy(-COOH) groups. Preference is given to alcohol(-OH), or amino(-NH₂) groups. X is a terminal methyl(-CH₃), ethenyl(-C═CH₂), ethinyl(-C≡CH), thiol(-SH), amino(-NH₂), hydroxy(-OH), carboxy(-COOH), epoxy, acrylate, or methacrylate group. Preference is given to methyl(-CH₃), ethenyl(-C═CH₂), thiol(-SH), amino(-NH₂), acrylate, or methacrylate groups.

R₄ is a branched or unbranched, saturated or unsaturated, substituted or unsubstituted, aliphatic, aromatic, or mixed aliphatic/aromatic polyvalent hydrocarbon group. The hydrocarbon group can comprise pendant chains and/or heteroatoms.

Preferred spacer groups (R_{Sp}) are unbranched alkanediyl moieties-(CH₂)ₓ—, where x=from 1 to 30, among which particular preference is given to —(CH₂)ₓ—, where x=from 1 to 12, and

the following unbranched alkanediyl moieties which include a heteroatom, multiple bonds, and/or aromatic systems:

-A-,

-A-(CH₂)ₓ—,

-A-(CH₂)ₓ-A-,

—(CH₂)ₓ-A-(CH₂)ₓ-.

-A-(CH₂)ₓ-A-(CH₂)ₓ-,

-A-(CH₂)ₓ-A-(CH₂)ₓ-A-,

—(CH₂)_{y}-A-(CH₂)_{y}-A-(CH₂)_{y}—,

-A-(CH₂)_{y}-A-(CH₂)_{y}-A-(CH₂)_{y}—,

-A-(CH₂)_{y}-A-(CH₂)_{y}-A-(CH₂)_{y}-A-,

—(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}-A-,

—(CH₂)_{z}-A-(CH₂)_{z}-A-(CH₂)_{z}-A-(CH₂)_{z}-A-(CH₂)_{z}—

where x=from 1 to 30, y=from 1 to 25, z=from 1 to 20, and the group of atoms A=-CH═CH—, —C≡C—, —C₆H₄—, —CO—O—, —CO—N—, —CO—O—CO—, —CO—NH—CO—, —NH—CO—NH—, oxygen(-O—), sulfur(-S₁₋₄—), or nitrogen(-NR—), where R═H, alkyl, or alkenyl, particularly preferably where x=from 1 to 20, y=from 1 to 15, z=from 1 to 10, and the group of atoms A=-CH═CH—, —C≡C—, oxygen(-O—), sulfur(-S₁₋₄—), or nitrogen(-NR—), where R═H, alkyl, or alkenyl.

Another aspect of the invention relates to another production process with the following steps:
silanization of the particulate solid with an organosilane which is capable of condensation with a di- or polyfunctional acyl chloride, in particular an aminoalkylsilane, carboxyalkylsilane, or hydroxyalkylsilane, or provision of a filler silanized in this manner;
reaction of the silanization product with the acyl chloride with formation of an amide, anhydride, or ester;
reaction of the resultant product with a hydroperoxy compound.

In this process the covalent bonding of the peroxy groups is achieved with the aid of organosilanes which are capable of forming covalent bonds with acyl chlorides. For the purposes of the process, these must in turn be at least bifunctional. When there is more than one acyl chloride function per molecule, on the one hand covalent bonding to the silane is achieved, and on the other hand reactive acyl chloride functionalities are retained at the surface. In a further step, these can be reacted with hydroperoxy compounds, and preferred hydroperoxy compounds here are the same as those already stated above.

Organofunctional silanes used which can form covalent bonds with acyl chlorides are preferably those which have, on the spacer (R_{Sp}), a preferably terminal amino, carboxy, or hydroxy functionality. The silanization is achieved under the conventional conditions, preferably with catalysis, and with the conventional hydrolyzable groups already mentioned above which bind the silicon atom to the filler by way of an oxygen bridge. A useful spacer group (R_{Sp}) between Si atom and the preferably terminal amino, carboxy, or hydroxy functionality is a branched or unbranched, saturated, mono- or polyunsaturated, aliphatic, or mixed aliphatic/aromatic, divalent C₁ to C₃₀ hydrocarbon group. The hydrocarbon group can comprise pendant chains and/or heteroatoms.

Preferred spacer groups (R_{Sp}) are unbranched alkanediyl moieties-(CH₂)ₓ—, where x=from 1 to 30, among which particular preference is given to —(CH₂)ₓ—, where x=from 1 to 12, and

the following unbranched alkanediyl moieties which include a heteroatom, multiple bonds, and/or aromatic systems:

-A-,

-A-(CH₂)ₓ—,

-A-(CH₂)ₓ-A-,

—(CH₂)ₓ-A-(CH₂)ₓ—,

-A-(CH₂)ₓ-A-(CH₂)ₓ—,

-A-(CH₂)ₓ-A-(CH₂)ₓ-A-,

—(CH₂)_{y}-A-(CH₂)_{y}-A-(CH₂)_{y}—,

-A-(CH₂)_{y}-A-(CH₂)_{y}-A-(CH₂)_{y}—,

-A-(CH₂)_{y}-A-(CH₂)_{y}-A-(CH₂)_{y}-A-,

—(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}-A-,

—(CH₂)_{z}-A-(CH₂)_{z}-A-(CH₂)_{z}-A-(CH₂)_{z}-A-(CH₂)_{z}—

where x=from 1 to 30, y=from 1 to 25, z=from 1 to 20, and the group of atoms A=-CH═CH—, —C≡C—, —C₆H₄—, —CO—O—, —CO—N—, —CO—O—CO—, —CO—N—CO—, —NH—CO—NH—, oxygen(-O—), sulfur(-S—), or nitrogen(-NR—), where R═H, alkyl, or alkenyl preferably having terminal amino, hydroxy, or carboxy group, particularly preferably where x=from 1 to 20, y=from 1 to 15, z=from 1 to 10, and the group of atoms A=-CH═CH—, —C≡C—, oxygen(-O—), or nitrogen(-NR—), where R═H, alkyl, or alkenyl preferably having terminal amino, hydroxy, or carboxy group.

Examples of suitable silanes are 3-aminopropyltrimethoxysilane, 3-aminopropyltriethoxysilane, 4- aminobutyltriethoxysilane, 2- aminoethyl-3-aminopropyltrimethoxysilane, 11-aminoundecyltriethoxysilane, and hydroxymethyltriethoxysilane.

As coupling reagent it is possible to use any of the acyl chlorides that have at least two acyl chloride functions per molecule. The acyl chloride groups here can be bonded directly to one another in the case of oxalyl chloride, or via other moieties. Suitable moieties between the acyl chloride groups are branched or unbranched, saturated or unsaturated, substituted or unsubstituted, aliphatic, aromatic, or mixed aliphatic/aromatic polyvalent hydrocarbon groups. Preference is given to unbranched alkanediyl moieties-(CH₂)ₓ—, where x=from 1 to 12, among which particular preference is given to —(CH₂)ₓ—, where x=from 1 to 6, and the following unbranched alkanediyl moieties which include heteroatoms, multiple bonds, and/or aromatic systems.

-A-,

-A-(CH₂)ₓ—,

-A-(CH₂)ₓ-A-,

—(CH₂)ₓ-A-(CH₂)ₓ—,

-A-(CH₂)ₓ-A-(CH₂)ₓ—,

-A-(CH₂)ₓ-A-(CH₂)ₓ-A-,

—(CH₂)_{y}-A-(CH₂)_{y}-A-(CH₂)_{y}—,

-A-(CH₂)_{y}-A-(CH₂)_{y}-A-(CH₂)_{y}—,

-A-(CH₂)_{y}-A-(CH₂)_{y}-A-(CH₂)_{y}-A-,

—(CH₂)_{z}-A-(CH₂)_{z}-A-(CH₂)_{z}-A-(CH₂)_{z}—,

where x=from 1 to 12, y=from 1 to 8, z=from 1 to 4, and the group of atoms A=-CH═CH—, —C≡C—, —C₆H₄—, —C₆H₃—, —CO—O—, —CO—N—, —CO—O—CO—, —CO—N—CO—, —NH—CO—NH—, oxygen(-O—), sulfur(-S—), or nitrogen(-NR—), where R═H, alkyl, or alkenyl preferably having a terminal acyl chloride group, particularly preferably where x=from 1 to 6, y=from 1 to 4, z=from 1 to 3, and the group of atoms A=-CH═CH—, —C≡C—, oxygen(-O—), or nitrogen(-NR—), where R═H, alkyl, or alkenyl preferably having a terminal acyl chloride group.

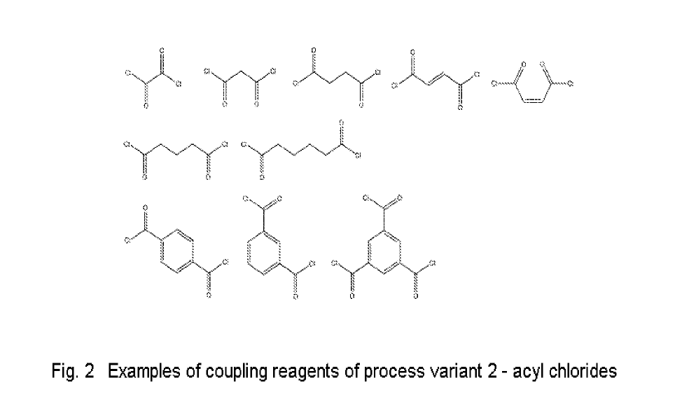

Examples of particularly preferred coupling reagents are oxalyl chloride((COCl)₂), malonyl dichloride(COCl—CH₂—COCl), succinyl chloride(COCl—(CH₂)₂—COCl), fumaryl dichloride(COCl—CH═CH—COCl), maleyl dichloride(COCl—CH═CH—COCl), glutaryl chloride(COCl—(CH₂)₃COCl), adipyl chloride(COCl—(CH₂)₄—COCl), 1,3-benzenedicarbonyl dichloride(C₆H₄(COCl)₂), 1,4-benzenedicarbonyl dichloride (C₆H₄(COCl)₂), and 1,3,5-benzenetricarbonyl trichloride(C₆H₃(COCl)₃). These are also depicted in FIG. 2.

The process can be modified in that other nucleophiles (e.g. amines, thiols, carboxylic acids, or alcohols) are provided, alongside the hydroperoxy compounds (simultaneously or sequentially) for reaction with the acyl chloride. It is thus possible to achieve hydrolysis-resistant covalent bonding of a very wide variety of compounds and, respectively, functionalities on the surface. These additional groups serve for the modification of the interface between filler and polymer during use of the resultant solid material in reinforced plastics and, respectively, hybrid materials. The interface of the two materials and the nature of the interaction have a decisive effect on the properties of the target material. It is thus possible to influence polarities and polarity differences in the materials.

Suitable nucleophiles are compounds of the general formula IV

Nu-R₄—X (IV)

where Nu denotes the nucleophilic group, R₄ denotes an organic group of atoms, and X denotes a functional group. Nucleophilic groups can be alcohol(-OH), amino(-NH₂), thiol(-SH), or carboxy(-COOH) groups. Preference is given to alcohol(-OH), or amino(-NH₂) groups. X is a terminal methyl(-CH₃), ethenyl(-C═CH₂), ethinyl(-C≡CH), thiol(-SH), amino(-NH₂), hydroxy(-OH), carboxy(-COOH), epoxy, acrylate, or methacrylate group. Preference is given to methyl(-CH₃), ethenyl(-C═CH₂), thiol(-SH), amino(-NH₂), acrylate, or methacrylate groups.

R₄ is a branched or unbranched, saturated or unsaturated, substituted or unsubstituted, aliphatic, aromatic, or mixed aliphatic/aromatic polyvalent hydrocarbon group. The hydrocarbon group can comprise pendant chains and/or heteroatoms.

Preferred spacer groups (R_{Sp}) are unbranched alkanediyl moieties-(CH₂)ₓ—, where x=from 1 to 30, among which particular preference is given to —(CH₂)ₓ—, where x=from 1 to 12, and

the following unbranched alkanediyl moieties which include heteroatoms, multiple bonds, and/or aromatic systems:

-A-,

-A-(CH₂)ₓ—,

-A-(CH₂)ₓ-A-,

—(CH₂)ₓ-A-(CH₂)ₓ—,

-A-(CH₂)ₓ-A-(CH₂)ₓ—,

-A-(CH₂)ₓ-A-(CH₂)ₓ-A-,

—(CH₂)_{y}-A-(CH₂)_{y}-A-(CH₂)_{y}—,

-A-(CH₂)_{y}-A-(CH₂)_{y}-A-(CH₂)_{y}—,

-A-(CH₂)_{y}-A-(CH₂)_{y}-A-(CH₂)_{y}-A-,

—(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}—,

-A-(CH₂)_{z}-A-(CH₂)_{z}-A-(CH₂)_{z}-A-(CH₂)_{z}-A-,

—(CH₂)_{z}-A-(CH₂)_{z}-A-(CH₂)_{z}-A-(CH₂)_{z}-A-(CH₂)_{z}—

where x=from 1 to 30, y=from 1 to 25, z=from 1 to 20, and the group of atoms A=-CH═CH—, —C≡C—, —C₆H₄—, —CO—O—, —CO—N—, —CO—O—CO—, —CO—NH—CO—, —NH—CO—NH—, oxygen(-O—), sulfur(-S₁₋₄-), or nitrogen(-NR—), where R═H, alkyl, or alkenyl, particularly preferably where x=from 1 to 20, y=from 1 to 15, z=from 1 to 10, and the group of atoms A=-CH═CH—, —C≡C—, oxygen(-O—), sulfur(-S₁₋₄-), or nitrogen(-NR—), where R═H, alkyl, or alkenyl.

The reaction between the acyl-chloride-modified solid and the hydroperoxy compound is preferably carried out in a basic medium. The bases used (e.g. triethylamine, pyridine, . . . ) serve to scavenge resultant HCl, and to shift the reaction equilibrium toward the product side. The use of the bases is optional. The entire synthesis is to be carried out under anhydrous conditions.

The process parameters, pressure, temperature, concentration, and reaction time are to be selected appropriately by the person skilled in the art by analogy with known processes for the constituent reactions.

Another process in a third aspect of the present invention comprises the following steps:
silanization of the particulate solid with an acryloxy, methacryloxy or epoxysilane, or provision of a filler silanized in this manner;
reaction of the solid during the silanization in a one-pot reaction or reaction of the silanization product (base-catalyzed) with a hydroperoxy compound.

In this process variant, the solid is first presilanized with an acryloxy or methacryloxysilane, and the acrylates can function as coactivators here. This has the advantage that when reaction is incomplete the unreacted acrylic groups are also capable of interacting with the polymer. In the step that follows, the peroxy anion enters into an addition reaction with the electron-deficient double bond of the silane, and is thus introduced on the surface by a covalent mechanism.

The hydrolyzable groups of the acryloxy or methacryloxysilanes are the same as those described above. The spacer (Rₛₚ), too, is the same as described in the first aspect of the invention (page 10). Examples of suitable silanes are 3-(methacryloxy)propyltrimethoxysilane, and 3-(acryloxy)propyltrimethoxysilane. Hydroperoxy compounds used are likewise those already described above.

In a preferred embodiment, the bonding of the peroxides is phase-transfer-catalyzed.

In another aspect of the invention it is possible to use epoxysilanes instead of the acryloxy or methacryloxysilanes, and here again the hydrolyzable groups and the spacer (Rₛₚ) are the same as in the first aspect of the invention. This variant involves a ring-opening reaction where the peroxy anion enters into an addition reaction with the epoxy group. Again, covalent bonding of the peroxy group on the surface is achieved. The resultant groups here are in each case peroxyorganosiloxane groups, anchored on the surface of the solid.

Examples of epoxysilanes that can be used are 3-glycidyloxypropyltrimethoxysilane and 3-glycidyloxypropyltriethoxysilane.

The invention further comprises the use of the particulate solid made of inorganic oxidic compounds of the elements Si, Al, Mg, Ca, Zn, Zr, Ti—individually or in a mixture—functionalized in this invention with peroxyorganosiloxane groups, as filler for polymers, in particular elastomers amenable to free-radical crosslinking, also in combination with other fillers and other additional substances.

In principle, it is possible to use the particulate solid of the invention as filler whenever a peroxide is used as additive in the mixture that is to be polymerized or that is to be crosslinked, as is the case in free-radical polymerization with peroxide and in free-radical crosslinking with peroxide. When appropriately high concentrations of the particulate solid of the invention are used, this can indeed entirely replace the peroxide used as additive. The particulate solids of the invention were preferably developed for these applications, and they are therefore particularly suitable therefor. Simultaneous use of other conventional additives together with the functionalized filler of this invention is not excluded. Additives of this type are known to the person skilled in the art, and they do not therefore require any detailed mention here.

Polymers or elastomers in the polymer mixtures or elastomers in which the particulate solid of the invention can be used as filler can therefore be any of the polymers or elastomers known to the person skilled in the art.

The invention also comprises a heat-crosslinkable polymer mixture, in particular a rubber mixture, which comprises a particulate solid of the invention. The particulate solid is used here as filler within the mixture, as already described above.

The invention further comprises technical polymer items or technical elastomer items which comprise a particulate solid as claimed in claim 1 or 2, bound into the polymer or elastomer. Items of this type are in particular tires, tire components, drive belts, drive belt components, air springs, conveyor belts, hoses, and gaskets, and also any of the other parts and components that have been produced from the heat-crosslinkable polymer mixture of the invention, or with concomitant use of said mixture.

The invention is explained in more detail hereinafter with reference to embodiments which are intended to serve solely for illustration of the various procedures and of possible products, without restricting the general applicability of the invention described above.

### SYNTHESIS EXAMPLE 1

### (Two-Stage Peroxyalkylsilanization) of Aspect 1

Step 1: 15 g of Ultrasil® VN3 precipitated silica were dispersed in 450 ml of toluene. The suspension was heated to 80° C. 4.68 ml of DBU and 8.73 ml of bromoundecyltrimethoxysilane were added in the sequence mentioned to the suspension. The mixture was stirred at 80° C. for 2 h. After cooling, the reaction mixture was filtered on a P4 frit, and the filter cake was washed repeatedly with ethanol. The resultant solid was dried in vacuo.

The carbon content of the silanized silica was determined by means of elemental analysis as w(C)=7.3%. This corresponds to a theoretical surface coating of 0.55 mmol of silane per gram of silica.

Step 2: 0.174 g of KOH pulverized in a mortar, 0.105 g of Bu₄NHSO₄, and 0.48 ml of tert-butyl hydroperoxide (70% in H₂O₂) were combined at RT in 30 ml of THF, with stirring. 0.75 g of the presilanized silica from step 1 were added to this mixture. The mixture was heated to 50° C. for 2 h, with stirring. After cooling, the reaction mixture was filtered on a P4 frit, and washed twice with 30 ml of water, twice with 30 ml of water/THF mixture (1:1), twice with 30 ml of water, and finally four times with 30 ml of THF. The resultant solid was dried in vacuo.

Product Characterization

The peroxide concentration of the synthesized filler particles was determined by means of iodometric titration with exclusion of oxygen. The titration gave a peroxide concentration of 0.30 mmol of peroxide groups per gram of filler. This corresponds to 55% yield.

The surface functionalization can reduce BET surface area. BET surface areas determined for the synthesized filler particles were up to 170 m²/g, where the BET surface area of the starting material is 175 m²/g.

DSC was carried out on the synthesized filler particles in order to determine the decomposition temperature of the peroxide functionality formed. The silica presilanized in step 1 was also tested as control. No exothermic signal is observed for the bromoalkylsilane-presilanized silica. In contrast, after the reaction described in step 2 a distinct exothermic signal is identifiable in the range of about 170 to 180° C. The decomposition temperature for the grafted peroxide groups is therefore within the desired range that is conventional for peroxidic crosslinking processes, and the synthesized filler particles can easily be mixed into polymers. The high decomposition temperature is evidence of the covalent bonding of the peroxide, since the decomposition temperature of the hydroperoxide used is only about 90° C.

A thermal desorption test was carried out on the filler particles produced in step 2. For this, a weighed input quantity of sample was first taken, and was controlled to a temperature of 100° C. for 15 min in a stream of helium. A defined portion of the material isolated by freezing in a cold trap here was then studied by means of GC/MS. The same sample was then controlled to a temperature of 180° C. for a further 15 min, and again the freezing and subsequent analysis procedure was used.

The only materials detected at 100° C. were some solvent and a small quantity of tert-butanol derived from the peroxide group. This shows that the grafted peroxide groups are stable for some time at 100° C., with only slight decomposition.

At 180° C. materials detected were: further solvent, BHT present therein, and a fragment from the phase-transfer catalyst. Alongside these impurities, further tert-butanol was detected, at greatly increased concentration. The greatly increased tert-butanol signal shows that at 180° C. decomposition of the grafted peroxide has occurred. It was thus possible to demonstrate directly the successful formation of the peroxide functionality on the silica surface.

Filler-Polymer Binding

A bound rubber analysis was carried out in order to study the binding of polymer on the silica described in step 2. References used here are untreated Ultrasil® VN3 and Dynasylan®-Octeo-presilanized Ultrasil® VN3, in order to replicate the effect of the hydrophobization of the silica. 10 phr of each of the fillers were mixed on a roll into an amorphous EPDM (BUNA EPG 3440). No crosslinking agent was added to the mixtures. The mixtures were heated at 180° C. for 20 min, so that the functionalized silica could react with the polymer. Bound rubber content was determined both on the crude mixtures and on the heated sheets.

Bound rubber was determined by comminuting 1.5 g of material from each of the mixtures (to give cubes of edge length about 2 mm), adding cyclohexane, and heating at reflux for 16 h in an ultrasound bath. The resultant suspensions were centrifuged (10 000 rpm, 30 min), again taken up in cyclohexane, and then again centrifuged. The resultant filler particles were dried overnight at 85° C. in a drying oven, and then thermogravimetric analyses (TGAs) were carried out both on the raw materials and on the extracted filler particles.

The TGAs of the fillers before mixing into the material show that the mass loss is smallest for untreated Ultrasil® VN3, being attributable to the evolution of water. The different chain lengths in the silicas are reflected in the mass losses, and are in agreement with the carbon analysis results.

All of the filler particles extracted from crude mixtures exhibit mass losses at approximately the same level. The effects exhibited by the peroxide-functionalized filler particles in the crude mixture are unchanged from those of the references. The exothermic signal for the peroxide groups also continues to be clearly visible in DSC.

The mass losses of the extracted filler particles of the untreated Ultrasil® VN3 and of the Dynasylan®-Octeo-presilanized Ultrasil® VN3 from the heated mixtures are at the same level as those of the crude mixtures. In contrast to this, a distinct increase (20%) of the mass loss is discernible for the peroxide-functionalized filler particles. The exothermic signal still observed in the crude mixtures in DSC is moreover no longer present here. From this it can be concluded that the peroxide groups have led to binding of the polymer.

The filler particles with covalently grafted peroxide functionalities are accordingly capable of reacting with crosslinkable or “vulcanizable” polymers, and of binding same securely at their surface. This can improve the physical and dynamic properties of the vulcanizates.

### SYNTHESIS EXAMPLE 2

### (Three-Stage Peroxyorganylsilanization by Way of Amine/Acyl chloride) of Aspect 2

Step 1: 15 g of Ultrasil® VN3 precipitated silica were dispersed in 450 ml of toluene. The suspension was heated to 80° C. 4.68 ml of DBU and 4.74 ml of aminopropyltrimethoxysilane were added to the suspension in the sequence mentioned, with stirring. The mixture was stirred at 80° C. for 2 h. After cooling, the reaction mixture was filtered on a P4 frit, and the filter cake was repeatedly washed with ethanol. The resultant solid was dried in vacuo.

The carbon content of the silanized silica was determined by means of elemental analysis as w(C)=4.0%. This corresponds to a theoretical surface coating of 1.11 mmol of silane per gram of silica.

Step 2: 1.5 g of the silica presilanized in step 1 was used as initial charge under inert gas (Ar) in a scalded flask, and dispersed in 20 ml of absolute DCM. 1.18 ml of 1,3,5-benzenetricarbonyl trichloride were added to the above. The reaction mixture was heated at reflux in an ultrasound bath for 16 h. After cooling, the reaction mixture was filtered on a P4 frit, and washed five times, in each case with 20 ml of absolute DCM, while here again the inert gas conditions were continuously maintained. The resultant solid was dried for 2 h at 10⁻² mbar.

Step 3: All of the surface-functionalized silica produced in step 2 was used as initial charge under inert gas (Ar) in a flask, and cooled to 0° C. 20 ml of absolute MTBE, 1.84 ml of triethylamine, and 1.60 ml of tert-butyl hydroperoxide (5.5 M in decane) were then added. The mixture was stirred at 0° C. for 5 h. The reaction mixture was filtered on a P4 frit, washed twice with in each case 20 ml of EtOH, twice with in each case 20 ml of water, twice with in each case 20 ml of water/THF mixture (1:1), twice with in each case 20 ml of water, and finally four times with in each case 20 ml of THF. The resultant solid was dried in vacuo.

Product Characterization

The peroxide concentration of the synthesized filler particles was determined by means of iodometric titration with exclusion of oxygen. The titration gave a peroxide concentration of 0.31 mmol of peroxide groups per gram of filler.

The surface functionalization can reduce BET surface area. BET surface areas determined for the synthesized filler particles were 26 m²/g, where the BET surface area of the starting material was 175 m²/g.

The pH of the filler particles is in the slightly acidic region between pH 5 and 7.

The decomposition temperature of the resultant peroxide-functionalized filler particles was determined by means of DSC. DSC was also carried out on the presilanized Ultrasil® VN3 from step 1, and on the acyl-chloride-treated filler particles from step 2, after hydrolysis of these, in order to provide control values. No exothermic signals were observed in DSC for either of the precursors providing control values. In contrast, the peroxide-functionalized filler exhibits a distinct exothermic signal at 160° C. The decomposition temperature of the grafted peroxide groups is therefore in the desired range.

The covalent binding of the peroxide is also apparent from this, since the decomposition temperature of the hydroperoxide used is only about 90° C.

By analogy with example 1, here again thermal desorption was used to study the resultant filler particles. However, operations here were carried out at 80° C. and 160° C., because of the lower decomposition temperature. At 80° C., only very little tert-butanol was detected. This shows that the grafted peroxide decomposes only slightly at 80° C.

Materials detected at 160° C. comprised a small amount of ethanol and BHT. As in example 1, alongside these impurities a large increase of tert-butanol concentration was recorded. The greatly increased tert-butanol signal shows that at 160° C. decomposition of the grafted peroxide has occurred. It was thus possible to demonstrate directly the successful formation of the peroxide functionality on the silica surface.

Filler-Polymer Binding

A bound rubber analysis was carried out in order to study the binding of polymer on the silica described in step 3. References used here were untreated Ultrasil® VN3 and Dynasylan®-Octeo-presilanized Ultrasil® VN3, in order to replicate the effect of the hydrophobization of the silica. The particles produced in step 1, the particles produced and hydrolyzed in step 2, and the peroxide-functionalized filler particles produced in step 3 were also mixed into the material.

The following samples were subjected to testing:

VN3/untreated

VN3/Dynasylan® Octeo

VN3/aminosilane

VN3/aminosilane/1,3,5-benzenetricarbonyl trichloride/hydrolyzed

VN3/aminosilane/1,3,5-benzenetricarbonyl trichloride/TBHP

10 phr of each of the fillers were mixed on a roll into an amorphous EPDM (BUNA EPG 3440). No crosslinking agent was added to the mixtures. The mixtures were heated at 160° C. for 20 min, so that the functionalized silica could react with the polymer. Bound rubber content was determined both on the crude mixtures and on the heated sheets.

Bound rubber was determined by comminuting 1.5 g of material from each of the mixtures (to give cubes of edge length about 2 mm), adding cyclohexane, and heating at reflux for 16 h in an ultrasound bath. The resultant suspensions were centrifuged (10 000 rpm, 30 min), again taken up in cyclohexane, and then again centrifuged. The resultant filler particles were dried overnight at 85° C. in a drying oven, and then thermogravimetric analyses (TGAs) were carried out both on the raw materials and on the extracted filler particles.

The TGAs of the fillers before mixing into the material shows that the mass loss is smallest for untreated Ultrasil® VN3, being attributable to the evolution of water. The different chain lengths in the silicas are reflected in the mass losses, and are in agreement with the carbon analysis results. The stepwise increase of organic matter on the surface in the individual reaction steps is also observable.

The mass losses in the bound rubber determinations on the crude mixtures are found to be at a similar level for all five samples. The effects exhibited by the peroxide-functionalized filler particles in the crude mixture are unchanged from those of the references. By means of DSC it is also still possible to detect the peroxide in the crude mixture.

The mass losses of the extracted filler particles of the untreated Ultrasil® VN3 and of the Dynasylan®-Octeo-presilanized Ultrasil® VN3 from the heated mixtures are at the same level as those of the crude mixtures. For each of the extracted fillers having the amino and, respectively, carboxy functionalities a small increase of the bound rubber value is observed. In contrast to this, for the peroxide-functionalized filler particles a distinct increase (26%) of the mass loss is discernible. The exothermic signal of the peroxide in DSC has disappeared. From this it can be concluded that the peroxide groups have led to binding of the polymer.

The enclosed figures show:

FIG. 1—Free radicals of preferred hydroperoxy compounds

FIG. 2—Examples of coupling reagents of process variant 2—acyl chlorides

What is claimed is:

1-11. (canceled)

12. A particulate solid comprising an inorganic oxidic compound of Si, Al, Mg, Ca, Zn, Zr, or Ti, wherein the inorganic oxidic compound comprises a peroxyorganosiloxane group.

13. The particulate solid of claim 12, wherein the peroxyorganosiloxane group comprises the following structure II: 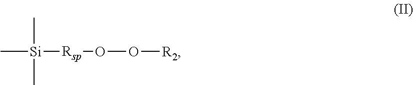
where Rₛₚ is a linear or branched spacer group of aliphatic, arylic, or mixed aliphatic/arylic structure,
and R₂ is a branched or unbranched, saturated or unsaturated, substituted or unsubstituted, aliphatic, aromatic, or mixed aliphatic/aromatic monovalent hydrocarbon group.

14. The particulate solid of claim 13, wherein Rₛₚ comprises at least one of a heteroatom, a multiple bond, an ether, an amide, an ester, and an anhydride.

15. The particulate solid of claim 13, wherein R₂ comprises at least one of methyl(-CH₃), ethyl(-CH₂—CH₃), n-propyl(-(CH₂)₂—CH₃), isopropyl(-CH(CH₃)—CH₃), n-butyl(-(CH₂)₃—CH₃), isobutyl(-CH₂—CH(CH₃)—CH₃), tert-butyl(-C(CH₃)₃), 1,1-dimethylbenzyl(-CH₂—C(CH₃)₂—C₆H₅), 1-methylbenzyl(-CH₂—CH(CH₃)—C₆H₅), benzyl(-CH₂—C₆H₅), acetyl(-CO—CH₃), propanoyl(-CO—CH₂—CH₃), benzoyl(-CO—C₆H₅), m-chlorobenzoyl(-CO—C₆H₄Cl), and p-chlorobenzoyl(-CO—C₆H₄Cl). Particular preference is given to methyl(-CH₃), tert-butyl(-C(CH₃)₃), 1,1-dimethylbenzyl(-CH₂—C(CH₃)₂—C₆H₅), acetyl(-CO—CH₃), and Benzoyl(-CO—C₆H₅).

16. A process for the production of the particulate solid of claim 12, comprising:
silanization of a solid with an organosilane to form a silanized solid or provision of the silanized solid, wherein the organosilane comprises at least one nucleophilically substitutable leaving group per molecule, and
reaction of the silanized solid with a hydroperoxy compound.

17. The process of claim 16, wherein silanization of the solid to form the silanized solid, and reaction of the silanized solid with the hydroperoxy compound are conducted in a one-pot reaction.

18. The process of claim 16, wherein the reaction of the silanized solid with the hydroperoxy compound is catalyzed by a phase-transfer catalyst.

19. The process of claim 16, wherein the hydroperoxy compound comprises an alkyl hydroperoxide, an aromatic hydroperoxide, or an alkyl or aryl peroxycarboxylic acid.

20. The process of claim 16, further comprising reacting the silanized solid with at least one other nucleophile.

21. The process of claim 20, wherein the at least one other nucleophile is selected from the group consisting of an alcohol, an amine, a thiol, and a carboxylic acid.

22. A process for the production of the particulate solid of claim 12, comprising:
silanization of a solid with an organosilane to form a silanized solid or provision of the silanized solid, wherein the organosilane is capable of condensation with a di- or polyfunctional acyl chloride;
reaction of the silanized solid with the di- or polyfunctional acyl chloride to form a reaction product comprising an amide, an anhydride, or an ester;
reaction of the reaction product with a hydroperoxy compound.

23. The process of claim 22, wherein the acyl chloride is selected from the group consisting of an aminoalkylsilane, a carboxyalkylsilane, and a hydroxyalkylsilane.

24. The process of claim 22, wherein the reaction of the silanized solid with the hydroperoxy compound is catalyzed by a phase-transfer catalyst.

25. The process of claim 22, wherein the hydroperoxy compound comprises an alkyl hydroperoxide, an aromatic hydroperoxide, or an alkyl or aryl peroxycarboxylic acid.

26. The process of claim 22, further comprising reacting the silanized solid with at least one other nucleophile.

27. The process of claim 26, wherein the at least one other nucleophile is selected from the group consisting of an alcohol, an amine, a thiol, and a carboxylic acid.

28. A process for the production of the particulate solid of claim 1, comprising either:
silanization of a solid with an acryloxy, an methacryloxy or an epoxysilane to form a silanized solid or provision of the silanized solid, and
reaction of the silanized solid with a hydroperoxy compound.

29. The process of claim 28, wherein silanization of the solid to form the silanized solid, and reaction of the silanized solid with the hydroperoxy compound are conducted in a one-pot reaction.

30. The process of claim 28, wherein the reaction of the silanized solid with the hydroperoxy compound is catalyzed by a phase-transfer catalyst.

31. The process of claim 28, wherein the hydroperoxy compound comprises an alkyl hydroperoxide, an aromatic hydroperoxide, or an alkyl or aryl peroxycarboxylic acid.

32. The process of claim 28, further comprising reacting the silanized solid with at least one other nucleophile.

33. The process of claim 32, wherein the at least one other nucleophile is selected from the group consisting of an alcohol, an amine, a thiol, and a carboxylic acid.

34. A method of using the particulate solid of claim 12, comprising mixing the particulate solid with a polymer.

35. The method of claim 34, wherein the polymer comprises an elastomer amenable to free radical crosslinking.

36. A composition comprising a polymer or elastomer bonded to the particulate solid of claim 12.
